(19) United States
(12) Patent Application Publication
(10) Pub. No.: US 2003/0037481 A1
(43) Pub. Date: Feb. 27, 2003

(54) Livewell net

(76) Inventor: Edmond Richard Brown, Trion, GA (US)

Correspondence Address: EDMOND RICHARD BROWN, 125 CHERRY STREET, TRION, GA, 30753, US

(21) Appl. No.: 09/939,329

(22) Filed: Aug. 27, 2001

(51) Int. Cl. A01K 97/04; A01K 97/00

(52) U.S. Cl. 43/55

(57) ABSTRACT

My invention is a net designed to fit inside a boats live-well to eliminate the need to place hands in the water inside the live-well to remove fish that have been caught. Fishermen have had to catch their fish one at a time and risk being bitten, cut or finned trying to remove their catch. With The Livewell Net installed they simply grab the handles and lift The Livewell Net out fish and all in one motion. No more frozen wet fingers or clothes and they don't have to remove coats or roll up sleeves.

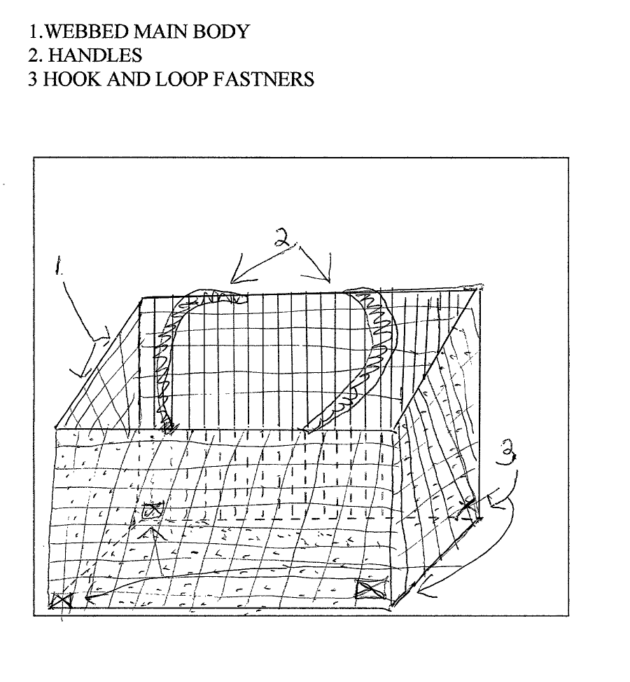

### BACKGROUND

Fishing aid that will help boat fishermen safely remove fish from their livewell

### BRIEF SUMMARY

A net that installs in a boats livewell so fishermen do not have to place their hands in the water with the fish. This makes it easier and safer to handle live fish. It will eliminate the need to handle each individual fish.

### DRAWINGS

Drawings show the simple parts of the LIVEWELL NET.

1. Webbed material (main body of net)

2. Handles (for lifting net out)

3. Hook and loop type fasteners (on some models)

### DETAILED DESCRIPTION OF LIVEWELL NET

The LIVEWELL NET is a net that will be installed in a boats livewell to make removal of fish easier. It will conform to the walls of the livewell. The LIVEWELL NET can be made of flexible netting or molded plastic or rubber. The flexible net models will use a two piece hook and loop fastener to hold the net in place, one attached to the livewell and the other to the net. The molded plastic or rubber model will not need any fasteners. The handles on top of the LIVEWELL NET will allow the fisherman to simply lift the net out with the fish. The LIVEWELL NET will be made of nylon, cotton, or mono netting, or molded plastic or rubber depending on the model no.

1. What I claim as my invention is net like device that is installed in a boats livewell to make removal of fish faster, safer and easier. This net will be made out of several different materials depending on the model ordered. These materials can be nylon cotton, monofilliment, or molded rubber or molded plastic. I have found no evidence that any other invention does what the LIVEWELL NET is designed to do. My invention will allow fishermen to handle the task of removing fish from their live-wells faster,easier,safer and with less stress on the fish. This invention will also help the survival rate of fish that are released during tournaments because it eliminates the need to chase the fish around the livewell and remove them one at a time.
